(19) United States
(12) Patent Application Publication
(10) Pub. No.: US 2003/0223572 A1
(43) Pub. Date: Dec. 4, 2003

(54) Apparatus and method for detecting a tone disconnect signal in the presence of voice

(76) Inventor: Larry John Roybal, Westminster, CO (US)

Correspondence Address: John C. Moran, Attorney, P.C., 4120 E. 115th Place, Thornton, CO, 80233, US

(21) Appl. No.: 10/161,491

(22) Filed: May 31, 2002

(51) Int. Cl. H04M 1/00; H04M 3/00

(52) U.S. Cl. 379/372

(57) ABSTRACT

Energy cadence detector detects a signaling tone in the presence of voice by requiring multiple cycles of the tone to be detected before detection is indicated.

### TECHNICAL FIELD

This invention relates generally to telecommunication systems, and relates specifically to determining the presence of a busy tone disconnect signal in such a system.

### BACKGROUND OF THE INVENTION

Within a telecommunication network comprising a number of telecommunication switching systems, telephone calls are set up between a first telephone connected to a first telecommunication system and a second telephone connected to a second telecommunication system. The first and second telecommunications switching systems are interconnected by a number of telephone links. When a first telephone hangs up, the first telecommunication switching system must signal the second telecommunication switching system that the first telephone has hung up. This signaling is referred to as disconnect signaling or disconnect supervision over the telephone link being utilized for the telephone call between the first and second telephones. Within the common art, it is well known that if the telephone link is a digital link that digital signaling is utilized to indicate the disconnect. Other telephone links utilize what is referred to as DC signaling to indicate a disconnect on a telephone link. DC signaling can take the form the first telecommunication switching system reversing the DC polarity on the telephone link or removing momentarily the DC power supplied to the telephone link. However, the prior art also utilizes a more difficult form of disconnect signaling to detect. This disconnect signaling consists of the first telecommunication switching system transmitting a busy tone to the second telecommunication switching system when the first telephone hangs up. The problem with detecting a tone during a voice conversation is that the frequencies within the human voice may be detected as the busy tone or the other tone being utilized for a disconnect signal. Since the second telecommunication switching system has no way of knowing when the first telecommunication switching system will cause the disconnect, the tone detection must be done during all of the voice conversation. Indeed, the party connected directly to the second telecommunication system may even continue to speak for a small amount of time after the busy tone is applied by the first telecommunication switching system. The main problem is however the fact that the tone detector must be active during the voice conversation and may erroneously identify the disconnect tone whereas it is simply a human voice. Within the art it is known to attach a separate detection device to the telephone link to monitor the telephone link for the busy tone at all times. When this separate device detects the busy tone it transmits a message to the telecommunication switching system indicating that disconnect signaling has been received from the distant telecommunication switching system which terminates the telephone link. These devices attempt to filter out the voice, while looking for the frequency characteristics of the busy tone. Further, the use of Busy Tone Detector or Phantom Caller Detector devices is complicated because in different countries, the busy tone is defined by many combinations of frequencies and cadences, and these devices require signal training during installation, and periodically thereafter.

Tone detection using cadence detection is known in the art. U.S. Pat. No. 5,719,932 discloses a signal recognition arrangement that utilizes cadence tables to recognize a variety of tones including busy tone. However, prior art cadence tone detectors are designed to quickly identify the tone and assume that there is no voice present while the tone detection is taking place. For example, the system disclosed in the above-referenced patent will detect a tone in less than a full cycle of the energy periods of the tone if there is no possibility of the correct indication being another tone. Hence, the system disclosed in the above-referenced patent can detect a tone in one cadence of energy. A cadence of energy is a period of energy and a period of no energy within the signal being detected. Whereas, this is highly desirable for certain applications, the ability to make such a rapid detection leaves such detectors vulnerable to erroneous indications when human voice is present during the detection time.

### SUMMARY OF THE INVENTION

The prior art problems and disadvantages are solved by an apparatus and method that utilize energy cadence detection that requires multiple cycles of the tone to be detected occur before detection is indicated.

### BRIEF DESCRIPTION OF THE DRAWING

FIG. 1 illustrates, in block diagram form, an embodiment of the invention;

FIG. 2 is a diagram of a cadences of an illustrative cadenced signal;

FIG. 3 illustrates, in flowchart form, operations performed by an embodiment of the invention;

FIG. 4 illustrates, in block diagram form, an embodiment of the invention;

FIGS. 5A-5D are diagrams of cadences of four illustrative cadenced signals;

FIG. 6 illustrates, in block diagram form, cadence timing table-pairs constructed according to an embodiment of the invention;

FIG. 7 illustrates, in block diagram form, an embodiment of the invention; and

FIG. 8 illustrates, in flowchart form, operations performed by one embodiment of the invention.

### DETAILED DESCRIPTION

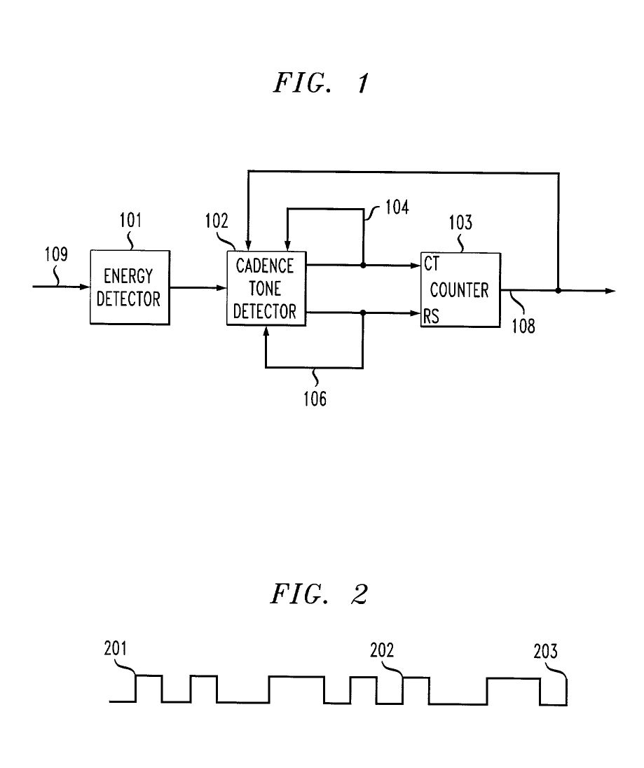

FIG. 1 illustrates one embodiment of the invention. The tone cadence detector illustrated in FIG. 1 consists of energy detector 101 which receives the incoming audio signal and reduces this to a pulse of energy or a pulse of non-energy (hereafter referred to as silence). Cadence tone detector 102 is responsive to the output of energy detector 101 to determine if a complete cycle of the tone being detected for has occurred. FIG. 2 illustrates an example of a tone. Note, that the actual busy tone is a much simpler tone than the tone illustrated in FIG. 2. A complete cycle of the tone illustrated in FIG. 2 occurs from point 201 to point 202 the next cycle of the tone is from point 202 to point 203. If cadence tone detector 102 detects the first cycle from point 201 to point 202, it indicates a match on output line 104. This match signal increments counter 103 and signals cadence tone detector 102 to start detecting for the next cycle. If cadence tone detector 102 fails to detect any portion of the cycle, it transmits a mismatch signal on line 106. The mismatch signal resets counter 103 and resets cadence tone detector 102. If cadence tone detector 102 detects a sufficient number of cycles of the tone as indicated by counter 103 transmitting a tone detect signal on line 108 counter 103 is reset and cadence tone detector 102 is stopped.

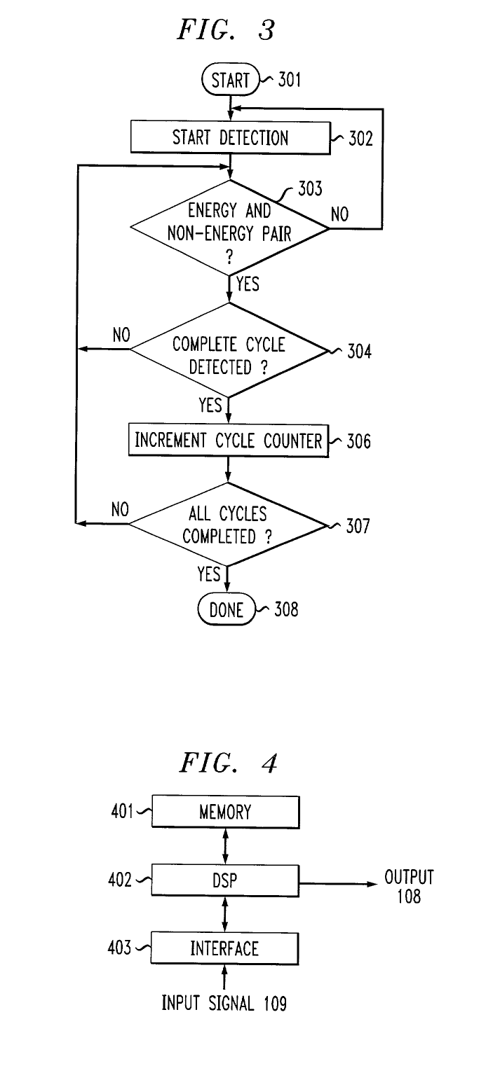

FIG. 3 illustrates, in flowchart form, operations performed in an implementation of the invention as illustrated in FIG. 1. After being started in block 301, the start detection process is initiated by block 302. Decision block 303 determines if an energy and non-energy pair has been detected that are part of the signal that is being detected. If the answer is no, control is transferred back to block 302. If the answer is yes, decision block 304 determines if a complete cycle has been detected. If the answer is no, control is transferred back to decision block 303 to detect another energy/non-energy pair. If the answer in decision block 304 is yes, block 306 increments the cycle counter, and decision block 307 determines if all the necessary cycles have been completed. If the answer is no, control is transferred back to decision block 303. If the answer is yes, control is transferred to block 308 which will signal that the tone has been detected.

FIG. 4 illustrates in block diagram form, a processor for implementing the flowchart illustrated in FIG. 3. Although processor 402 is illustrated as being a digital signal processor (DSP) this processor could be a general purpose processor or could be implemented utilizing hardware logic. Memory 401 is utilized to store the program for the processor and to store intermediate data. The input signal 109 is received via interface 403.

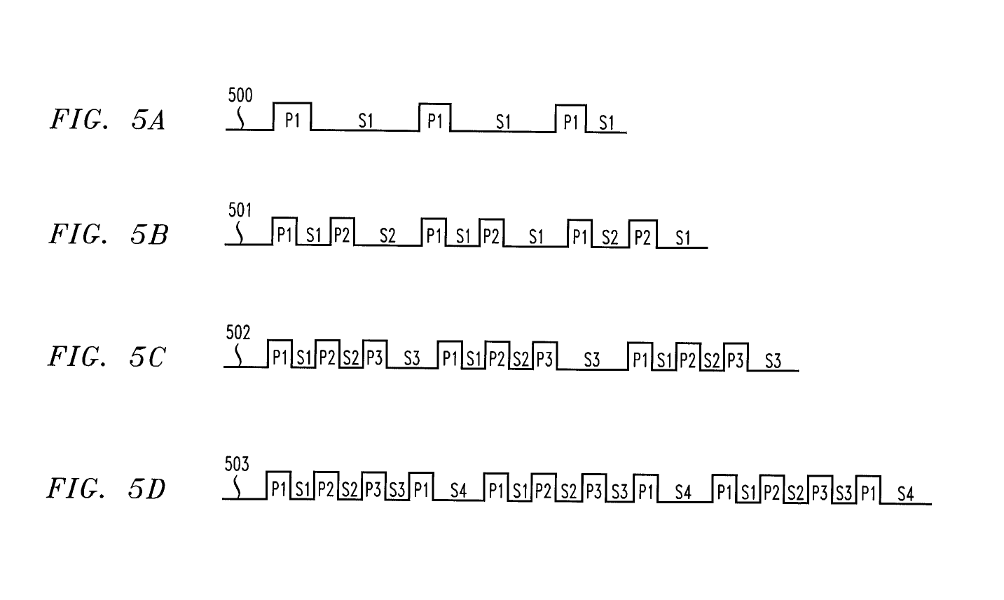

Consider now another embodiment of the invention that can detect multiple tones. FIGS. 5A-5D show the cadences of four illustrative signals 500-503 that may be detected. As shown in FIG. 5, cadence of a signal consists of a pattern of energy-ON periods and energy-OFF periods, which pattern may or may not repeat. The ON periods are depicted by a measurement P(n) and the OFF periods are depicted by a measurement S(n) where n=1, 2 . . . N. Each measurement P(n) and S(n) is either a time of duration or a count representative of the time of duration. A cadence consists of a minimum of one P/S pair. A repeating cadence consists of the number of P/S pairs that make up the repeating pattern. A non-repeating cadence consists of an infinite number of P/S pairs.

Because real-world signals can vary within some predetermined tolerance, each P(n) and S(n) can have a range of values—for example, .+−.10% of the normal value. That is, for each P(n) and S(n) to be considered a valid part of a cadence, its value must fall within the specified range of values.

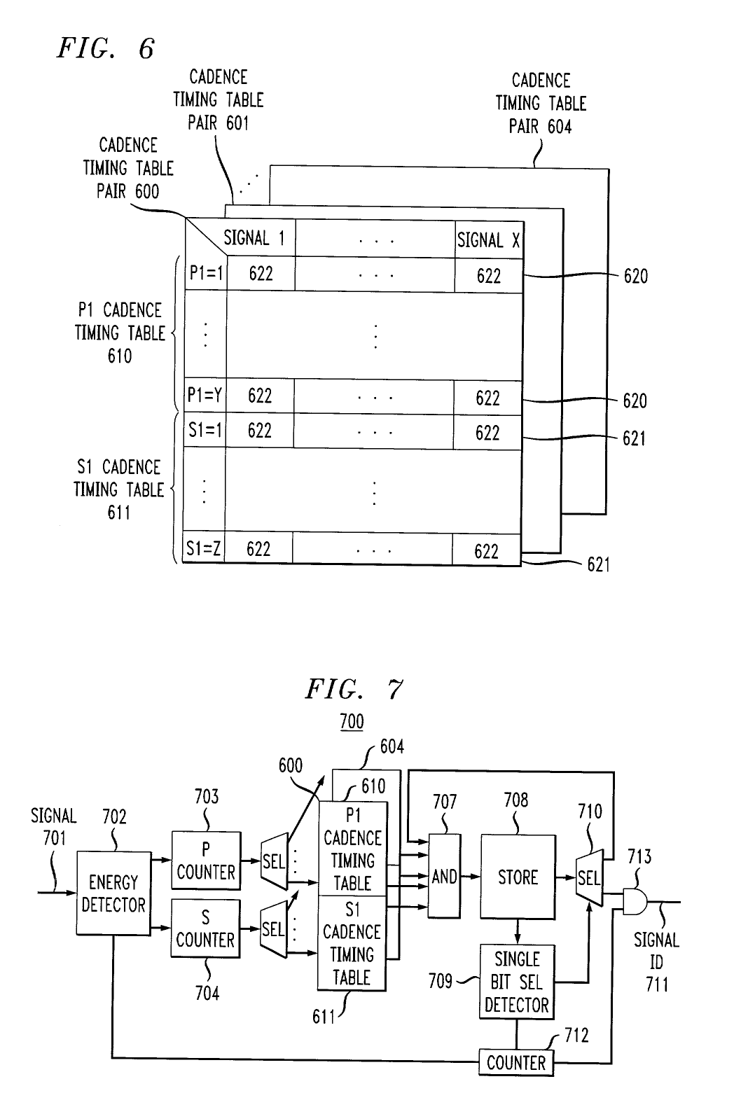

The signals that are sought to be recognized are defined by their cadences via cadence timing table-pairs 600-604 shown in FIG. 6. There are as many cadence timing table-pairs as the maximum number of P/S pairs that are needed to define the maximum number of cycles of the signal having the largest detect time. Each cadence timing table-pair 600-604 corresponds to a different value of (n): table-pair 600 corresponds to the P1/S1 pair; table-pair 601 corresponds to the P2/S2 pair; etc.; and table-pair 604 corresponds to the P(N)/S(N) pair.

Each cadence timing table-pair 600-604 consists of two tables 610, 611. Tables 610 define P(n) timing characteristics of the signals that are sought to be recognized, and are referred to as the P(n) cadence-timing tables, while tables 611 define S(n) timing characteristics, and are referred to as the S(n) cadence-timing tables. Each table 610, 611 contains a plurality of entries 620, 621, respectively. Entries 620, 621 are addressed by the values of the corresponding P(n) and S(n) measurements, respectively. That is, the measured values of P(n) and S(n) function as pointers into tables 610, 611. Each entry 620, 621 has a plurality of one-bit fields 622, one for each signal that is sought to be recognized. If the value of P(n) or S(n) that points to the corresponding entry 620, 621 characterizes the signal that corresponds to the field 622, its bit is set; otherwise it is not set. Hence, fields 622 whose bits are set in an entry 620, 621 identify those signals that are candidates for being the particular signal whose measured P(n) or S(n) value points to this entry 620, 621.

To define the signals that are sought to be detected, a system administrator populates cadence timing table-pairs 600-604 with the data that define those signals, by setting the appropriate bits of entries 620 and 621. To indicate a signal that is not to be detected, the administrator makes the entries 620 and 621 for that signal equal to zero. To change the signals that are sought to be detected, the system administrator changes the data contents of table-pairs 600-604. Consequently, the table-pairs 600-604 can be easily adapted for use with substantially any cadenced-signal signaling scheme.

As was mentioned above, real-world signals can vary within some predetermined tolerance range. This is reflected in table-pairs 600-604 by having adjacent entries 610 and 611 that span the allowable range of P(n) and S(n) values of an individual signal all identifying that signal as a candidate.

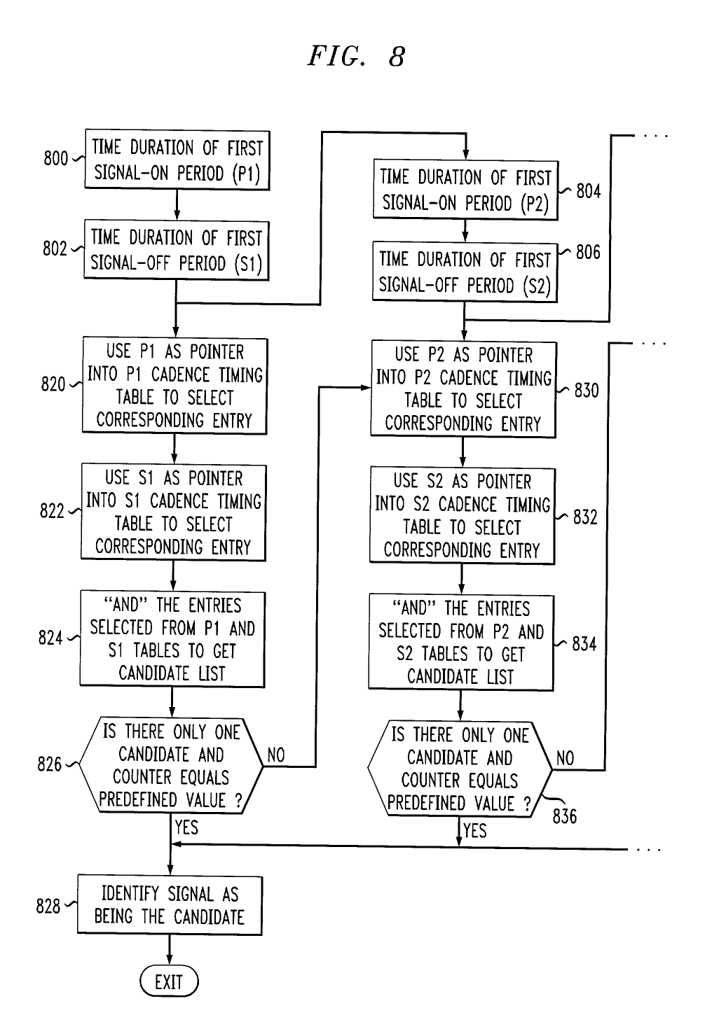

FIG. 7 shows a functional block representation of a signal-recognition engine 700 that is based on the cadence timing tables of FIG. 6. While engine 700 may be implemented in hardware, a preferred implementation is in software, via a program that executes on a processor—for example, on the control processor of a switching system such as a stored-program-controlled private branch exchange (PBX). The operation of engine 700 is flowcharted in FIG. 8.

During operations, counter 712 is initially set to count to a predefined value under control of energy detector 702. The predefined value is equal to the number of P/S pairs needed to determine the maximum number of cycles for the longest signal to be detected. Signals that are sought to be detected arrive at engine 700 via an input signal line 701 and enter an energy detector 702. Energy detector 702 monitors signal line 701 for presence and absence of signal energy. Energy detector 702 controls counter 712 to count one completed pair. When energy detector 702 detects signal energy on signal line 701, it resets and starts a P counter 703. P counter 703 then times the duration of the first signal-on period (P1), at step 800 of FIG. 8. When energy detector 702 ceases to detect signal energy on signal line 701, it stops P counter 703 and resets and starts S counter 704. S counter 704 then times the duration of the first signal-off period (S1), at step 802 of FIG. 8. When energy detector 702 again detects signal energy on signal line 701, it stops S counter 704 and again resets and starts P counter 703. P counter 703 then times the duration of the second signal-on period (P2), at step 804. When energy detector 702 again ceases to detect signal energy on signal line 701, it again stops P counter 703 and again resets and starts S counter 704. S counter 704 then times the duration of the second signal-off period (S2), at step 806. This procedure is repeated for the P3/S3 pair, etc., until the received signal is recognized and the operation of engine 700 ends, at step 850.

P and S counters 703 and 704 are respectively connected by selectors 705, 706 to P cadence timing tables 610 and S cadence timing tables 610 of table-pairs 600604. When energy detector 702 stops P counter 703 for the first time, selector 705 connects the count of P counter 703 as the measured P1 value to P1 cadence timing table 610 of table-pair 600; when energy detector 702 stops P counter 703 for the second time, selector 705 connects the count of P counter 703 as the measured P2 value to P2 cadence timing table 610 of cadence timing table-pair 601; etc. Similarly, when energy detector 702 stops S counter 704 for the first time, selector 706 connects the count of S counter 704 as the measured S1 value to S1 cadence timing table 611 of table-pair 600; when energy detector 702 stops S counter 704 for the second time, selector 706 connects the count of S counter 704 as the measured S2 value to S2 cadence timing table 611 of cadence timing table-pair 601; etc.

In table-pair 600, the P1 value is used as a pointer to select an entry 620 of P1 cadence timing table 610, at step 820, and the S1 value is used as a pointer to select an entry 621 of S1 cadence timing table 611, at step 822. These two selected entries are ANDed with each other by an AND function 707, at step 824, and the result is stored in a store 708. The result is a candidate list that identifies the signals which are candidates for being the signal that is being received on signal line 701. A single-bit-set detector 709 analyzes the contents of store 708 to determine whether only one bit is set in store 708, at step 826. If only one bit is set in store 708 and counter 712 equals the predefined value, the signal incoming on signal line 701 has been uniquely identified, at step 848, and single-bit-set detector causes a selector 710 to output the contents of store 708 via AND block 713 as the identifier of the recognized signal at a signal ID output 711. The signal-recognition engine of FIG. 7 then ends its operation, at step 850.

If it is determined at step 826 that more than one bit is set in store 708 or counter 712 doesn't equal the predefined value, the incoming signal has not yet been uniquely identified, and detector 709 causes selector 710 to provide the contents of store 708 as an input to AND function 707. Meanwhile, the measured P2 value is used as a pointer to select an entry 620 of P2 cadence timing table 610 of the next sequential cadence timing table-pair 601 in the sequence of table-pairs 600-604, at step 830, and the S2 value is used as a pointer to select an entry 621 of S2 cadence timing table 611 of that same one table-pair 601, at step 832. These two selected entries 620, 621 of table-pair 601 are ANDed with each other and with the contents of store 708 by AND function 707, at step 834, and the result is again stored in store 708. Detector 709 again analyzes the contents of store 708 to ascertain whether only one bit is set in store 708, at step 836. If only one bit is set in store 708 and counter 712 equals the predefined value, the signal incoming on signal line 701 has been uniquely identified, at step 848, and detector 709 causes selector 710 to output the contents of store 708 at the signal ID output 711. The operation of signal-recognition engine 700 then ends, at step 850. If more than one bit is set in store 708 or counter 712 does not equal the predefined value, the procedure described above for the P2/S2 pair is analogously repeated for the P3/S3 pair, and so on, until the incoming signal is uniquely recognized or a match does not occur.

If detector 709 ever determines that no bits are set in store 708, the incoming signal cannot be recognized, and detector 709 generates a mismatch indication that resets counter 712 and causes the detection process to restart.

The above discussion has been greatly simplified by the assumption that a signal received on signal line 701 is always received from its beginning, that is, starting with the beginning of its cadence—with its P1/S1 pair. In the real world, that is not always the case, however: a signal may start being received at any point within its cadence—for example, the P3/S3 pair of a signal may be the first P/S pair received. For proper signal recognition, its is necessary to start the signal-recognition process with the signal origin, i.e., with the P1/S1 pair. U.S. Pat. No. 5,719,932 which has been previously incorporated by reference discloses such a technique for determining P1/S2 before starting the operations of FIG. 7.

Of course, various changes and modifications to the illustrative embodiment described above will be apparent to those skilled in the art. Such changes and modifications can be made without departing from the spirit and scope of the invention and without diminishing its intended advantages. It is therefore intended that such changes and modifications be covered by the following claims except in so far as limited by the prior art.

What is claimed is:

1. A method for detecting a signaling tone in the presence of voice in a signal, comprising the steps of:
(a) converting the signal to a cadence signal;
(b) detecting for a complete cycle of the signaling tone in the cadence signal;
(c) incrementing a count of complete cycles of the signaling tone detected upon a complete cycle having been detected in the step (b);
(d) comparing the count with a predefined value;
(e) repeating the steps (b), (c), and (d) if the count is less than the predefined value; and
(f) indicating that the signaling tone has been detected if the count is equal to or greater than the predefined value.

2. The method of claim 1 wherein the step (c) comprises the steps of setting count equal to zero and repeating the steps (b) and (c) if a complete cycle was not detected.

3. The method of claim 1 wherein the step (b) comprises the step of converting the signaling tone to a cadence signaling tone.

4. A method for detecting a signal in the presence of voice, comprising the steps of:
in response to receiving a signal comprising a cadence of signal-on intervals interleaved with signal-off intervals, measuring durations of sequential ones of the signal-on intervals and measuring durations of sequential ones of the signal-off intervals;
incrementing a count for each pair of signal-on and signal-off intervals;
using sequential measured signal-on interval durations in a sequence of a plurality of first tables each corresponding to a different signal-on interval in the cadence and having a plurality of entries, each entry corresponding to a different duration of the corresponding signal-on interval and identifying signals which have the corresponding signal-on interval duration as candidates for the received signal, to select the corresponding entries from sequential ones of the first tables;
using sequential measured signal-off interval durations in a sequence of a plurality of a second tables each corresponding to a different signal-off interval in the cadence and having a plurality of entries, each entry corresponding to a different duration of the corresponding signal-off interval and identifying signals which have the corresponding signal-off interval duration as candidates for the received signal, to select the corresponding entries from sequential ones of the second tables;
comparing together the entries selected from the first and the second tables to determine a single signal that is identified by each of the selected entries as a candidate for the received signal; and
indicating the received signal to be the determined candidate if the count equals a predefined value.

5. The method of claim 4 wherein the step of comparing comprises the step of resetting the count to zero if no signal is identified and repeating the steps of claim 4.

6. The method of claim 5 wherein:
said cadence comprises a sequence of at least one interval-pair each comprising one of the signal-on intervals and an adjacent one of the signal-off intervals;
the first and the second tables form a sequence of a plurality of table-pairs each corresponding to a different interval-pair of the cadence and comprising the first table corresponding to the signal-on interval of the corresponding interval-pair and the second table corresponding to the signal-off interval of the corresponding interval-pair;
the steps of using together comprise the step of
using the measured durations of the intervals in sequential interval-pairs to select a corresponding pair of entries, one entry of the pair from the first table and a second entry of the pair from the second table, of sequential ones of the table-pairs;
the step of comparing comprises the steps of
in response to an initial selected pair of entries, generating a candidate list identifying signals that are identified by both entries of the pair of selected entries, and in response to each non-initial selected pair of entries, generating a candidate list identifying signals that are identified by both entries of the pair of selected entries and a candidate list generated in response to a sequentially immediately-preceding selected pair of entries; and
the step of indicating comprises the step of
in response to a candidate list identifying only one signal as a candidate, indicating the received signal to be the one candidate signal.

7. The method of claim 5 wherein:
the signal comprises a repeating said cadence, said cadence comprising a sequence of at least one interval-pair each comprising one of the signal-on intervals and an adjacent one of the signal-off intervals, said cadence beginning with a first interval-pair; and
the steps of using use the measured interval durations of the first interval-pair and subsequent interval-pairs of the cadence; and
the step of comparing compares entries selected by use of measured interval durations of only the first interval-pair and subsequent interval-pairs of the cadence.

8. The method of claim 7 wherein:
the method comprises, as its first step, the step of
in response to receiving the signal, identifying the first interval-pair in the received signal.

9. An apparatus for detecting a signaling tone in the presence of voice in a signal, comprising:
a energy detector responsive to the signal for producing a cadence signal having signal-on intervals and signal-off intervals;
a counter for counting complete cycles of the signaling tone;
a cadence detector responsive to the detection of a complete cycle of the signaling tone for incrementing the counter; and
the counter indicating detection of the signaling tone upon the counter equaling a predefined value.

10. The apparatus of claim 9 wherein the cadence detector responsive to a complete cycle of the signaling tone not being detected for resetting the counter.

11. The apparatus of claim 9 wherein the cadence detector responsive to a complete cycle of the signaling tone not being detected for retrying to detect the signaling tone.

12. An apparatus for executing the steps of claim 4.

13. An apparatus for executing the steps of claim 5.

14. An apparatus for executing the steps of claim 6.

15. An apparatus for executing the steps of claim 7.
